(19) United States
(12) Patent Application Publication
(10) Pub. No.: US 2026/0288070 A1
(43) Pub. Date: Sep. 24, 2026

(54) EXTERIOR MEMBER, METHOD OF MANUFACTURING EXTERIOR MEMBER, AND TIMEPIECE

(71) Applicant: CASIO COMPUTER CO., LTD., Tokyo (JP)

(72) Inventors: Kazuyuki TANABE, Tokyo (JP); Shin HITSUMOTO, Tokyo (JP)

(21) Appl. No.: 19/575,107

(22) Filed: Mar. 23, 2026

(30) Foreign Application Priority Data
Mar. 24, 2025 (JP) 2025-048296

(51) Int. Cl. G04B 37/00; G04B 37/05

(52) U.S. Cl. CPC G04B 37/0008; G04B 37/05

(57) ABSTRACT

An exterior member includes a round plate member and a resins member. The resin member covers the front surface and the back surface of the plate member and is integrated with the plate member. On one surface side of the resin member, a screw part is formed that projects in one side of thickness directions of the plate member and that corresponds to an attachment target to which the exterior member is to be attached.

### CROSS-REFERENCE TO RELATED APPLICATIONS

This application is based upon and claims the benefit of priority from the prior Japanese Patent Application No. 2025-048296, filed on March 24, 2025, the entire contents of which are incorporated herein by reference.

### BACKGROUND OF THE INVENTION

### Technical Field

The present disclosure relates to an exterior member used for arm-wearable electronic devices and electronic devices such as portable communication devices, a method of manufacturing the exterior member, and a timepiece including the exterior member.

### Description of Related Art

Screw-in back covers (screw back covers) are commonly used as back covers of wristwatches. As the material of the back cover, metals such as titanium and stainless steel are often used, as described in Japanese Unexamined Patent Application Publication No. 2017-223572, for example.

### SUMMARY OF THE INVENTION

According to the present disclosure, an exterior member includes: a round plate member; and a resin member that covers a front surface and a back surface of the plate member and that is integrated with the plate member, wherein on one surface side of the resin member, a screw part is formed that projects in one side of thickness directions of the plate member and that corresponds to an attachment target to which the exterior member is to be attached.

### BRIEF DESCRIPTION OF DRAWINGS

FIG. 1 is a front view of a wristwatch.

FIG. 2 shows the back surface side of the wristwatch.

FIG. 3 is a cross-sectional view along the A-A line of FIG. 1.

FIG. 4 is an enlarged view of part B of FIG. 3.

FIG. 5 is a perspective view showing the outer surface side of a back cover.

FIG. 6 is a perspective view showing the inner surface side of the back cover.

FIG. 7 is a plan view of a plate member.

FIG. 8 is a cross-sectional view along the C-C line of FIG. 7.

FIG. 9 is a cross-sectional view of main part of a metal mold for molding the back cover.

FIG. 10 shows the positional relation between the plate member and fixing pins.

FIG. 11A is a plan view of the plate member in a modification.

FIG. 11B is a perspective view of the plate member of FIG. 11A.

### DETAILED DESCRIPTION

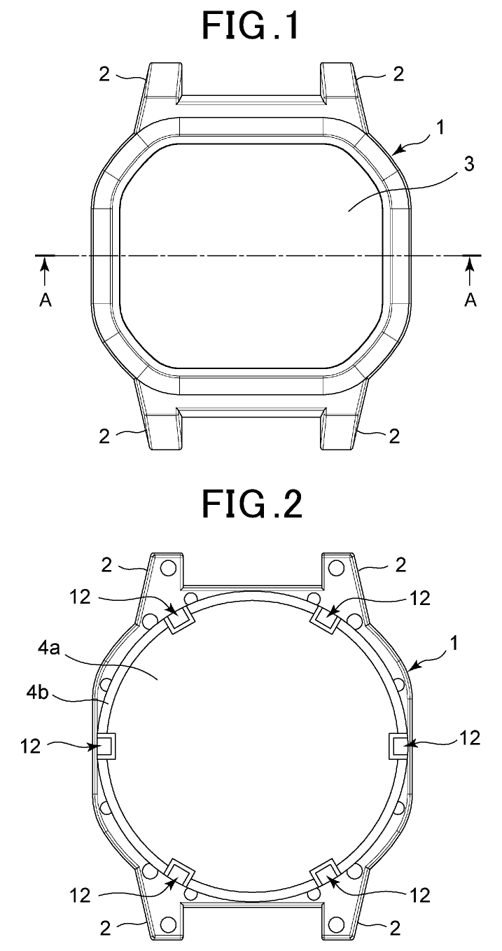

Hereinafter, an embodiment of the present disclosure will be described with reference to the drawings. FIG. 1 is a front view of a wristwatch to which this disclosure is applied. The wristwatch includes a case 1. The case 1 has band attachment parts 2 at the respective positions of 12 o'clock and 6 o’clock. Although not illustrated, a wristband is attachable to the band attachment parts 2.

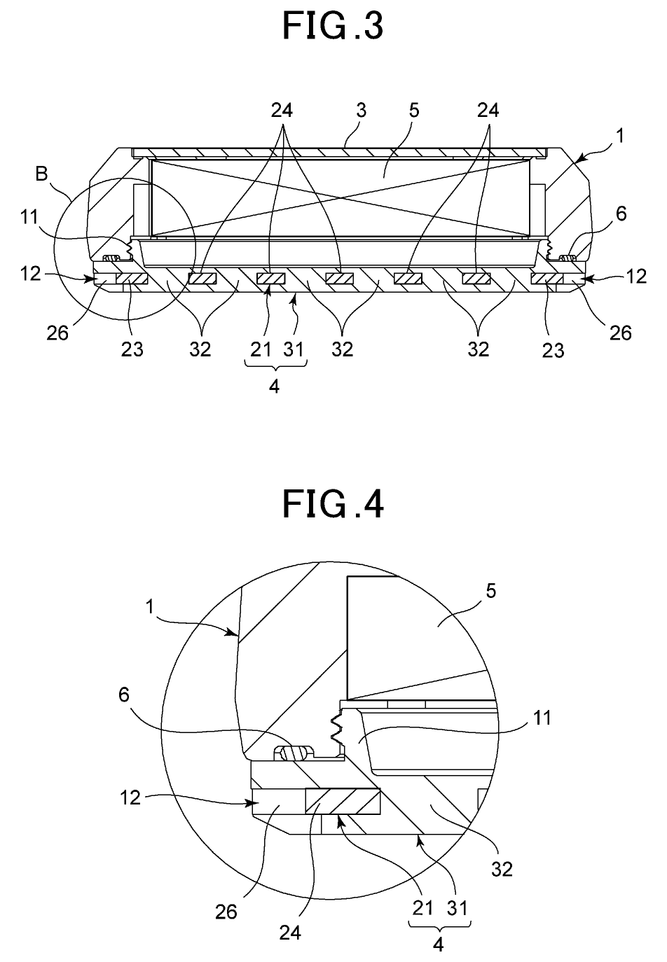

The front surface side of the case 1 is closed by a cover glass 3. The back surface side of the case 1 is closed by a back cover 4, as shown in FIG. 2. A watch module 5 is housed inside the case 1, as shown in FIG. 3. Although not illustrated in detail in FIG. 3, the watch module 5 includes various components necessary for the watch function, such as: a watch movement that moves hands to indicate the time; a flat display device that electro-optically displays various kinds of information, such as the time, date, and day of the week; and a circuit board that drives and controls the watch movement and the display device, for example.

As shown in FIG. 3, the back cover 4 has a screw-in structure. On the inner surface side of the back cover 4, a cylindrical screw part 11 is formed along the outer circumference of the back cover 4 to project toward the case 1. The screw part 11 is formed at a position inside the outer circumference of the back cover 4 in the radial direction. On the outer circumferential surface of the screw part 11, an external screw is formed. The back cover 4 is screwed into the back surface side of the case 1, thereby being fastened. Between the case 1 and the back cover 4, a waterproof gasket 6 is provided.

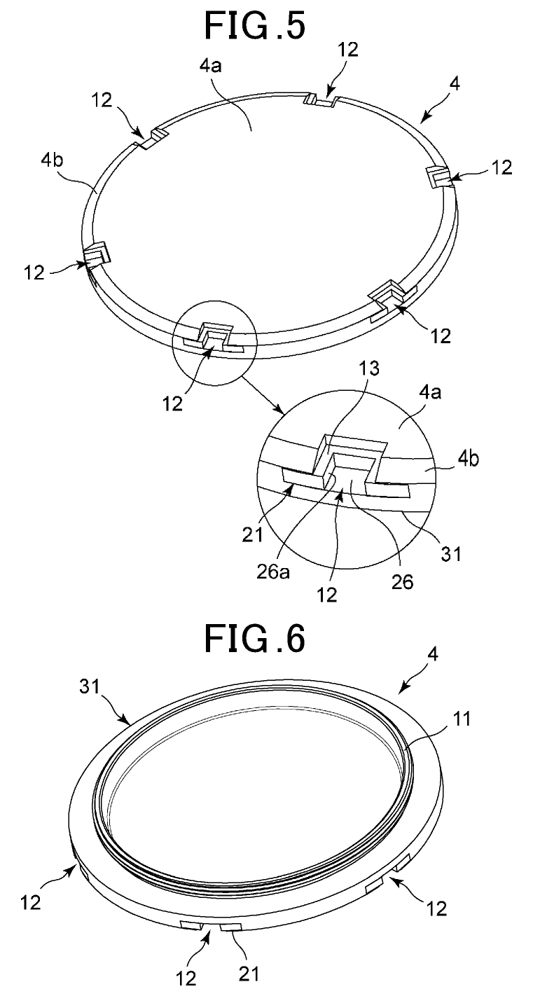

As shown in FIG. 2 to FIG. 6, the external shape of the back cover 4 is disc-shaped, which is substantially the same as a typical screw back cover. That is, as shown in FIG. 2 and FIG. 5, the outer surface of the back cover 4, which constitutes the back surface of the wristwatch, has a circular main surface 4a and a tapered surface 4b. The tapered surface 4b constitutes the outer circumferential side of the main surface 4a. On the outer circumferential side of the outer surface of the back cover 4, recesses 12 are formed. The recesses 12 are formed from the tapered surface 4b to the outer circumferential side of the main surface 4a at the positions corresponding to one o’clock, three o’clock, five o’clock, seven o’clock, and nine o’clock. The lateral side of each recess 12 is open. The shape of each recess 12 is rectangular in plan view. Such recesses 12 can receive prongs of an opening-closing tool (screw back opener), which is generally made of metal.

As shown in FIG. 3 and FIG. 4, a plate member 21 is provided within the back cover 4 to be parallel to the main surface 4a. That is, the back cover 4 consists of the plate member 21 and a resin member 31 that covers the front and back surfaces of the plate member 21 and that is integrated with the plate member 21. Herein, the surface of the plate member 21 on which the screw part 11 is provided is referred to as the front surface, and the opposite surface is referred to as the back surface. The plate member 21 is made of metal, such as stainless steel. The thickness of the back cover 4 at the part of the main surface 4a is approximately 2.5 mm. The thickness of the plate member 21 is approximately 1 mm. The outer dimensions of the plate member 21 (the overall maximum dimensions including outer projections 25 described below) are substantially the same as those of the back cover 4.

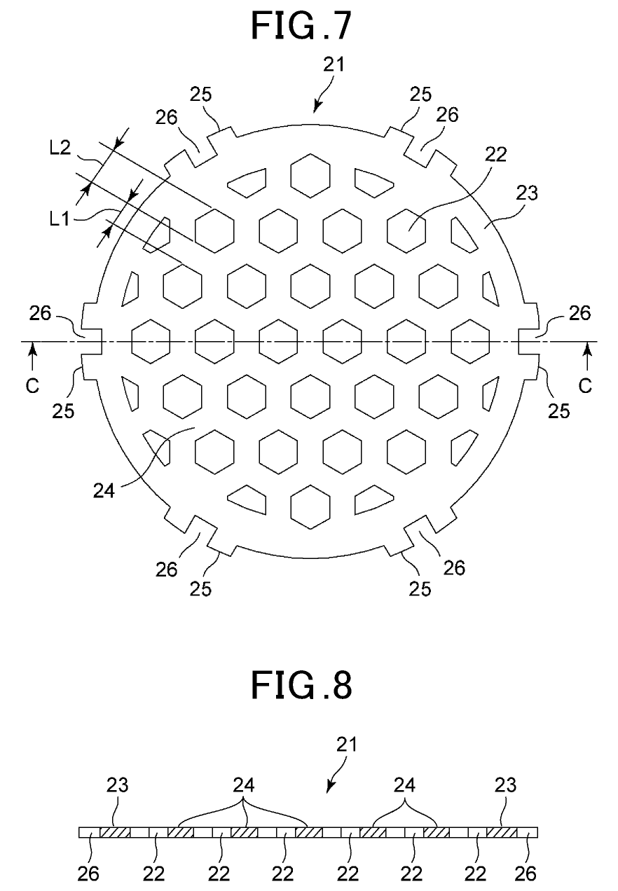

As shown in FIG. 7 and FIG. 8, the plate member 21 includes holes 22, an outer frame 23, and a hole frame 24. The holes 22 are formed adjacent to each other at regular intervals and penetrate through the front surface and the back surface of the plate member 21. The outer frame 23 constitutes the outer circumferential side of the plate member 21. The hole frame 24 is continuously formed around each of the holes 22. The hole frame 24 is formed to be continuous with the outer frame 23. At several positions of the outer frame 23 corresponding to the respective recesses 12 of the back cover 4, the outer projections 25 are formed. The outer projections 25 project outward and are continuous with the outer frame 23.

Each outer projection 25 has a rectangular notch 26 that opens outward (in the radial direction). Herein, the notches 26 are formed from the outer circumferential side toward the inner circumferential side of the outer frame 23 such that the notches 26 face at least part of the hole frame 24 with the outer frame 23 in-between. In other words, each notch 26 is formed such that the notch 26 and at least part of the hole frame 24 sandwich the outer frame 23. In a case where the notch 26 does not face the hole frame 24 (the notch 26 faces only the hole 22), the corresponding outer frame 23 becomes extremely thin. Therefore, the positional relation between the hole frame 24 and the notches 26 is defined so as to avoid making the outer frame 23 thin.

The holes 22 occupying almost the entire area of the plate member 21 except the holes 22 partially formed by the outer frame 23 have a regular hexagonal shape. The width L1 of the hole frame 24 between adjacent holes 22, namely the distance between the adjacent holes 22, is uniform. Thus, the plate member 21 has a honeycomb structure constituted by the holes 22 and the hole frame 24. The width L1 of the hole frame 24 is narrower than the distance L2 between two parallel sides of one hole 22.

With respect to the back cover 4, the resin member 31 covers the front surface, the back surface, and the outer circumferential surface except the outer projections 25 of the plate member 21. Further, the resin member 31 fills the holes 22. That is, the resin member 31 covers the whole plate member 21 and has filling parts 32 that fill the holes 22 (see FIG. 3 and FIG. 4).

The opening surface of each recess 12 formed at the outer circumferential part of the outer surface of the back cover 4 is constituted by the opening surface 26a of each notch 26 of the plate member 21. Inside each recess 12, the opening surface 23a of the notch 26 is exposed. Portions of the resin member 31 corresponding to the notches 26 are notched. On the outer surface of the back cover 4, U-shaped non-covered portions 13 are formed to surround the respective recesses 12. At the non-covered portions 13, the plate member 21 is exposed without being covered by the resin member 31. That is, each recess 12 of the back cover 4 is formed by the plate member 21 and the resin member 31.

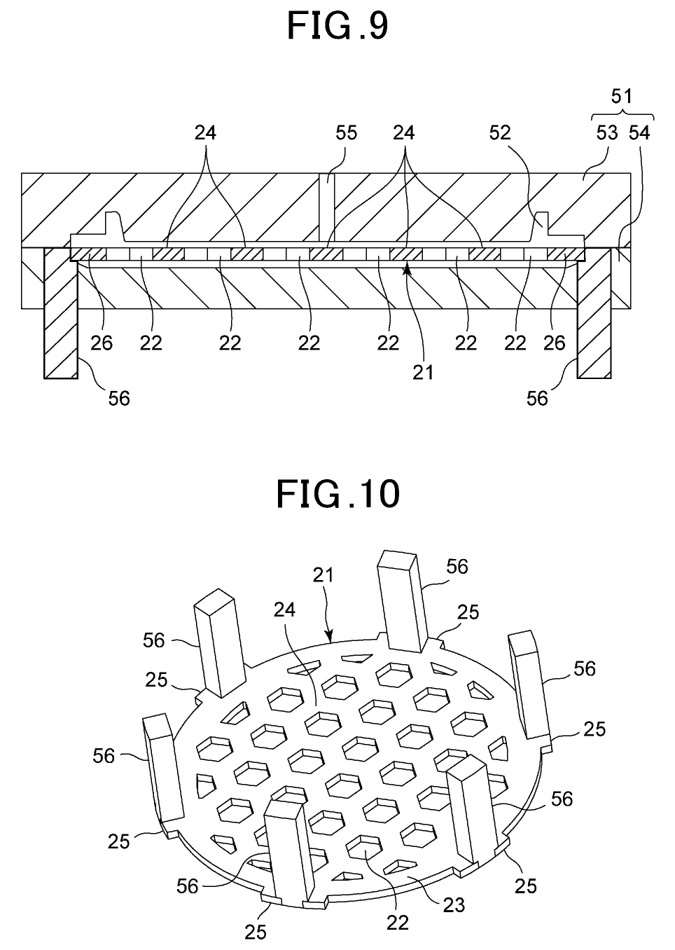

Next, the method of manufacturing the above back cover 4 will be described. In manufacturing the back cover 4, first, a plate member having the external shape shown in FIG. 7 is obtained from a metal plate material, such as a stainless-steel plate, by punching. The metal plate material is then perforated by double-sided etching, for example, to form the holes 22. Thus, the plate member 21 is formed (first process). Next, as shown in FIG. 9, the plate member 21 is positioned and fixed in a molding space (cavity) 52 in a metal mold 51 that is divided in thickness directions of the plate member 21 (second process).

The metal mold 51 includes an upper metal mold 53 and a lower metal mold 54 that are divided in the thickness directions of the plate member 21. The upper metal mold 53 corresponds to one surface of the resin member 31 that constitutes the inner surface side of the back cover 4. The upper metal mold 53 has a resin filling path 55 at the central part of the molding space 52. The lower metal mold 54 corresponds to the other side of the resin member 31 that constitutes the outer surface side of the back cover 4. The lower metal mold 54 has fixing pins 56 for fixing the position of the plate member 21 in midair in the molding space 52.

The fixing pins 56 are provided at positions corresponding to the respective outer projections 25 of the plate member 21. FIG. 10 shows the positional relation between the plate member 21 and the fixing pins 56. The tip of each fixing pin 56 is shaped to be in surface contact with the region corresponding to the non-covered portion 13, which is the outer projection 25 of the plate member 21, formed on the outer surface of the back cover 4. The tip of each fixing pin 56 is also shaped to fit in the notch 26 of the outer projection 25. Thus, the plate member 21 is certainly fixed at a position in midair in the molding space 52. Each of the fixing pins 56 is configured to magnetically attract the plate member 21 by magnetic force, which is given to the fixing pins 56 beforehand or supplied from outside.

After the plate member 21 is fixed at a position in midair in the molding space 52, resin is injected into the molding space 52 through the filling path 55 of the upper metal mold 53 (third process). Thus, the front and back surfaces in the thickness direction of the plate member 21 are covered by resin. Further, at the upper metal mold 53 side of the molding space 52, a cylindrical part corresponding to the screw part 11 is formed along the outer circumference so as to project in one side of the thickness directions of the plate member 21. At the same time, resin is supplied through the holes 22 of the plate member 21 to the lower metal mold 54 side of the molding space 52, namely to the other side of the plate member 21 in the thickness directions. While the resin is being injected, the fixing pins 56 keep magnetically attracting the plate member 21. Thus, the fixing pins 56 can certainly prevent the plate member 21 from moving in the thickness directions. Thereafter, an external screw is formed by threading, for example, on the circumference of the cylindrical part of the molded product removed from the metal mold 51 (forth process). By the above processes, the back cover 4 is manufactured.

According to the timepiece described in the known art JP2017-223572A, when a relatively deformable material (e.g., resin) is used for the back cover, the back cover needs to be thicker than a back cover made of only metal to ensure the required rigidity of the back cover. In contrast, the back cover 4 described above includes: the substantially round plate member 21; and the resin member 31 that is integrated with the plate member 21 and that covers the front and back surfaces of the plate member 21. On one surface side of the resin member 31, the hollow screw part 11 is formed that projects in one side of the thickness directions of the plate member 21 and that corresponds to the case 1 of the wristwatch (an attachment target). According to this configuration, the back cover 4 is lighter than a metal back cover, and the plate member 21 is inserted in the back cover 4. Therefore, even when the back cover 4 is partly made of the resin member 31, namely made of a deformable material, the back cover 4 can be appropriately attached and detached. Further, the back cover 4 can be made thin, which contributes to a thinner or lighter wristwatch to which the back cover 4 is attached. Although the screw part 11 is an external screw as an example, the screw part 11 can also be an internal screw, depending on the structure of the case 1 of the wristwatch.

In the back cover 4, the notches 26 are formed on the outer circumferential part of the plate member 21. Portions of the resin member 31 corresponding to the notches 26 are notched. With such notches, the back cover 4 can be attached to and detached from the case 1 of the wristwatch by using a general-purpose opening-closing tool for screw back covers. Further, the opening surface 26a of each notch 26 constitutes the opening surface of the recess 12. When the back cover 4 is attached or detached, the plate member 21 can directly receive the force from the opening-closing tool. Therefore, even when the back cover 4 is partially formed of the resin member 31, deformation of the back cover 4 in the attachment/detachment process can be prevented, and stronger tightening torque can be applied.

The opening surface of each notch 26 of the plate member 21 may not necessarily be exposed to the outside. The opening surface of each notch 26 may be thinly covered by a film of the resin member 31 without being exposed to the outside. Even in such a case, the back cover 4 can also be attached to or detached from the case 1 of the wristwatch with a general-purpose opening-closing tool. When the resin member 31 covers the opening surface of each notch 26, the resin member 31 can prevent corrosion of the metal plate member 21 from the notches 26 owing to deterioration over time. Further, covering the opening surfaces of the notches 26 can refine the design of the wristwatch. The positions of the recesses 12 in the back cover 4 are not limited to the outer circumferential part of the outer surface of the back cover 4. For example, the recesses 12 can be formed on the outer circumferential surface of the back cover 4 without extending into the tapered surface 4b.

In the above description, the recesses 12 that open on the lateral side are formed on the outer circumferential part of the outer surface of the back cover 4; and the notches 26 corresponding to the recesses 12 are formed on the outer circumferential part of the plate member 21. However, the present invention is not limited to this. The back cover 4 can also be configured without the recesses 12 on the outer circumferential part of the outer surface and without the notches 26 on the outer circumferential part of the plate member 21. In such a configuration, the resin member 31 may be formed such that the outer circumferential part of the outer surface of the back cover 4 has a polygonal shape, or fine protrusions and recesses may be formed on the entire outer circumferential side, for example. Such a back cover 4 can also be attached to or detached from the case by using the opening-closing tool. Even in such a case, the back cover 4 is lighter than a metal back cover and has a required level of rigidity against flexural deformation with the inserted plate member 21. Thus, even when the easily deformable resin member 31 is used for the back cover 4, the back cover 4 can be appropriately attached or detached.

In this embodiment, the notches 26 of the plate member 21 and the recesses 12 of the back cover 4 are rectangular. The shapes of the notches 26 and recesses 12 can be any shape and can be changed as needed. The number and positions of the notches 26 and the recesses 12 can also be changed as needed. Even in such cases, the same effect as the back cover 4 of the above embodiment can be obtained.

According to the back cover 4, the plate member 21 includes the outer frame 23 that constitutes the outer circumferential side; and the hole frame 24 that is formed to be continuous with the inner side the outer frame 23 and that forms the holes 22 penetrating through the front surface and the back surface of the plate member 21. The notches 26 are formed on the outer frame 23. Thus, the back cover 4 can be lightweighted while securing a certain level of rigidity against flexural deformation. Such a back cover 4 can be attached to or detached from the case the same way as a conventional screw-in back cover. Further, the notches 26 of the plate member 21 are formed from the outer circumferential side toward the inner circumferential side of the outer frame 23 so as to face at least part of the hole frame 24. Thus, the distance is secured between the notch 26 and the hole 22 adjacent to each other to avoid making the outer frame 23 thin. This prevents deformation of the back cover 4 owing to the operating force locally applied from the opening-closing tool in attaching or detaching the back cover 4. Further, stronger tightening torque can be secured.

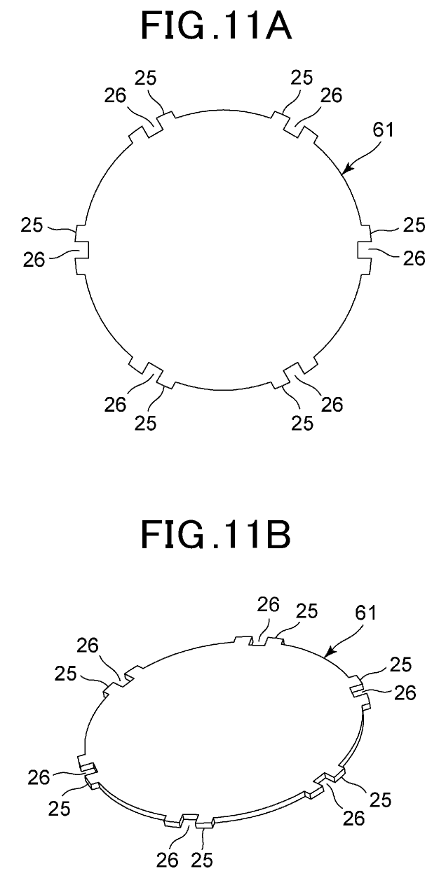

In this embodiment, the plate member 21 has a honeycomb structure in which the holes 22 have a regular hexagon shape. For another example, the plate member 21 can have a lattice-shaped hole frame 24, namely have rectangular holes 22. Such a structure also contributes to thinning and lightweighting the back cover, as compared with a back cover made of only resin. When the back cover 4 needs to be further thin, a different plate member 61 of any shape without holes 22 as shown in FIG. 11 can be used, instead of the plate member 21 having multiple holes 22.

Although the present disclosure is applied to the back cover of a wristwatch, the present disclosure is not limited to this example. The present disclosure is also applicable to exterior members constituting arm-wearable electronic devices, electronic devices such as portable communication devices, or mechanical wristwatches. The present disclosure is not limited to these examples but includes the disclosure set forth in the claims and their equivalents.

1. An exterior member comprising:
a round plate member; and
a resin member that covers a front surface and a back surface of the plate member and that is integrated with the plate member,
wherein on one surface side of the resin member, a screw part is formed that projects in one side of thickness directions of the plate member and that corresponds to an attachment target to which the exterior member is to be attached.

2. The exterior member according to claim 1, wherein:
the plate member has a notch on an outer circumferential part of the plate member, and
a portion of the resin member corresponding to the notch of the plate member is notched.

3. The exterior member according to claim 2, wherein at least part of the notch is exposed to an outside.

4. The exterior member according to claim 3, wherein the notch has a rectangular shape.

5. The exterior member according to claim 2, wherein:
the plate member includes:
an outer frame that constitutes an outer circumferential side of the plate member; and
a hole frame that is formed to be continuous with an inner side of the outer frame and that constitutes a hole penetrating through the front surface and the back surface of the plate member, and
the notch is formed on the outer frame.

6. The exterior member according to claim 5, wherein the notch is formed from the outer circumferential side toward an inner circumferential side of the outer frame so as to face at least part of the hole frame.

7. A timepiece comprising an exterior member used as a back cover, wherein:
the exterior cover includes a round plate member and a resin member that covers a front surface and a back surface of the plate member and that is integrated with the plate member, and
on one surface side of the resin member, a screw part is formed that projects in one side of thickness directions of the plate member and that corresponds to an attachment target to which the exterior member is to be attached.

8. The timepiece according to claim 7, wherein:
the plate member has a notch on an outer circumferential part of the plate member, and
a portion of the resin member corresponding to the notch of the plate member is notched.

9. The timepiece according to claim 8, wherein at least part of the notch is exposed to an outside.

10. The timepiece according to claim 9, wherein the notch has a rectangular shape.

11. The timepiece according to claim 8, wherein:
the plate member includes:
an outer frame that constitutes an outer circumferential side of the plate member; and
a hole frame that is formed to be continuous with an inner side of the outer frame and that constitutes a hole penetrating through the front surface and the back surface of the plate member, and
the notch is formed on the outer frame.

12. The timepiece according to claim 11, wherein the notch is formed from the outer circumferential side toward an inner circumferential side of the outer frame so as to face at least part of the hole frame.

13. A method of manufacturing the exterior member according to claim 5, the method comprising:
forming the plate member having the notch on the outer circumferential part from a plate-shaped material;
fixing the plate member at a position in a molding space of paired metal molds by fitting a tip end of a fixing part in the notch of the plate member, the fixing part being provided to one of the paired metal molds divided in the thickness directions of the plate member; and
ejecting resin into the molding space from a side of another of the paired metal molds.
